(19) United States
(12) Patent Application Publication
(10) Pub. No.: US 2009/0128033 A1
(43) Pub. Date: May 21, 2009

(54) Plasma Discharge Pixel That Provides a Plurality of Discharge Columns

(75) Inventor: Robert G. Marcotte, New Platz, NY (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Matsushita Electric Industrial Co., Ltd., Osaka (JP)

(21) Appl. No.: 11/990,030

(22) PCT Filed: Jul. 28, 2006
(86) PCT No.: PCT/US2006/029191

§ 371 Date: Feb. 5, 2008

Related U.S. Application Data
(60) Provisional application No. 60/705,778, filed on Aug. 5, 2005.

(51) Int. Cl. H01J 17/49

(52) U.S. Cl. 313/584

(57) ABSTRACT

There is provided a plasma display. The plasma display includes a pixel that, in turn, includes (a) a region for hosting a discharge of a gas, (b) a column electrode, (c) a row electrode, perpendicular to the column electrode, for providing a voltage to initiate the discharge, wherein the row electrode has a first protrusion and a second protrusion, and (d) a gap, between the first and second protrusions, having a width that separates the first protrusion from the second protrusion, wherein the gap is situated in the region.

### BACKGROUND OF THE INVENTION

1. Field of the Invention

The present disclosure relates to a pixel of a plasma display, wherein the pixel is configured to provide a plurality of discharge columns.

2. Description of the Related Art

A plasma display includes a front plate and a rear plate sealed together and having a space therebetween filled with a dischargeable gas. The front plate includes horizontal rows of electrodes, each row being configured with a sustain electrode in parallel with a scan electrode. The scan electrodes and the sustain electrodes are covered by a dielectric layer and a magnesium oxide (MgO) layer. The rear plate supports vertical barrier ribs and plural vertical column conductors. In a color display, individual column electrodes are covered with red, green, or blue (RGB) phosphors. A pixel is defined as a region proximate to an intersection of (i) a scan electrode and a sustain electrode, and (ii) three column conductors, one for each color. In a monochrome display, a single column conductor is used for each pixel, and a phosphor combination is used to achieve the monochromatic color. Visible light is emitted by the phosphors following UV excitation, produced when a voltage of a sufficient magnitude is applied across a volume of the gas to cause the gas to discharge. When the gas discharges, the atoms of the gas are excited, when the atoms relax, the atoms emit UV photons, which, in turn, excite the phosphor.

A discharge gap is a region of space between a scan electrode and a sustain electrode within which the discharge occurs. A positively charged electrode serves as an anode and a negatively charged electrode serves as a cathode. When a sufficient voltage is applied across the discharge gap, the gas will break down and form a discharge plasma. The discharge plasma has two distinct regions, namely a positive column and a negative glow. The positive column is predominantly composed of fast moving electrons seeking a positive charge on the surface of the anode electrode. Conversely, the negative glow contains slow moving ions drifting toward and across the negatively charged cathode electrode. The duration of the discharge is limited by the amount of charge on the dielectric surfaces of the electrodes.

Each discharge yields a certain level of brightness, and therefore a number of discharges in a predetermined period of time is chosen to meet an overall brightness requirement for an image being displayed. Light output from each discharge site is emitted at the discharge gap and above and below the electrodes that form the discharge gap. The dimension of space between adjacent electrodes, and the overall width of the electrodes, influence the pixel's discharge capacitance, which in turn influences discharge power and therefore brightness. There is a trade-off between electrode width and brightness because the electrodes tend to shade the emitted light.

In a traditional electrode topology, the plasma discharge funnels into a narrow conductive filament where the discharge is very intense. This physically narrow intense discharge causes erosion of the MgO surface and can damage the phosphor over the life of the plasma display.

There is a need in the art to improve the lifetime and luminous efficiency of plasma discharge devices, and there is a need for electrode topologies to improve efficiency where light blockage is reduced, and discharge power is reduced.

### SUMMARY OF THE INVENTION

There is provided a plasma display. The plasma display includes a pixel that, in turn, includes (a) a region for hosting a discharge of a gas, (b) an electrode for providing a voltage to initiate the discharge, wherein the electrode has a first protrusion and a second protrusion, and (c) a gap, between the first and second protrusions, having a width that separates the first protrusion from the second protrusion, wherein the gap is situated in the region.

### BRIEF DESCRIPTION OF THE DRAWINGS

FIG. 1 is an illustration of a pixel in a plasma display panel.

FIG. 2A is an illustration of a subpixel of FIG. 1, showing a formation of a discharge.

FIG. 2B is a photograph of a discharge of the subpixel of FIG. 2A.

FIG. 3 is an illustration of another configuration of a pixel.

FIG. 4 is an illustration of a subpixel of FIG. 3, showing a formation of a discharge.

FIGS. 5A, 5B and 5C are illustrations of other configurations of subpixels.

### DESCRIPTION OF THE INVENTION

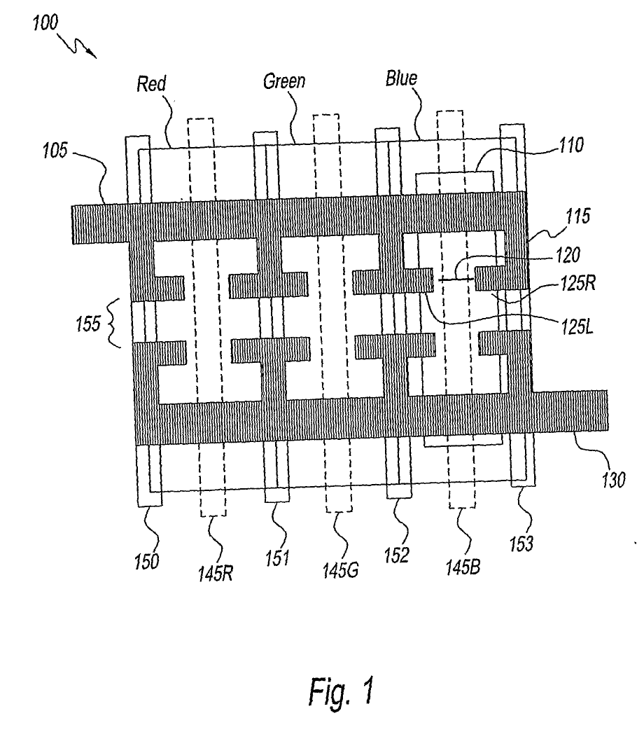

FIG. 1 is an illustration of a pixel 100 in a plasma display. The plasma display includes electrodes 105 and 130, barrier ribs 150, 151, 152 and 153, a red column electrode 145R, a green column electrode 145G, and a blue column electrode 145B. A discharge gap 155 is situated between electrodes 105 and 130.

Pixel 100 is configured to include a red subpixel, a green subpixel, and a blue subpixel. The red subpixel is a region in a vicinity of electrode 105, electrode 130, and red column electrode 145R, and is bounded on its sides by barrier ribs 150 and 151. The green subpixel is a region in a vicinity of electrode 105, electrode 130, and green column electrode 145G, and is bounded on its sides by barrier ribs 151 and 152. The blue subpixel is a region in a vicinity of electrode 105, electrode 130, and blue column electrode 145B, and is bounded on its sides by barrier ribs 152 and 153. The blue subpixel is designated in FIG. 1 as a subpixel 110.

The terms “pixel” and “subpixel” are used herein only to indicate a hierarchy in which the subpixel is a component of the pixel. Generally, any individually addressable picture element can be referred to as a pixel. The red subpixel, the green subpixel and the blue subpixel are individually addressable, and therefore could be referred to as a red pixel, a green pixel and a blue pixel, respectively, and subpixel 110, in spite of being designated as a “subpixel”, is a form of a pixel.

With appropriate voltages on electrodes 105, electrode 130, and blue column electrode 145B, there will be a discharge of a gas in the vicinity of subpixel 110. The region bounded by electrode 105, electrode 130, blue column electrode 145B and barrier ribs 152 and 153, is for hosting the discharge. For subpixel 110, electrode 105 is configured to include protrusions 125L and 125R. A gap 120 between protrusion 125L and protrusion 125R has a width that separates protrusion 125L from protrusion 125R. Gap 120 is situated in the region of subpixel 110 that hosts the discharge of the gas, and is approximately centered between barrier ribs 152 and 153, which form the side boundaries of subpixel 110.

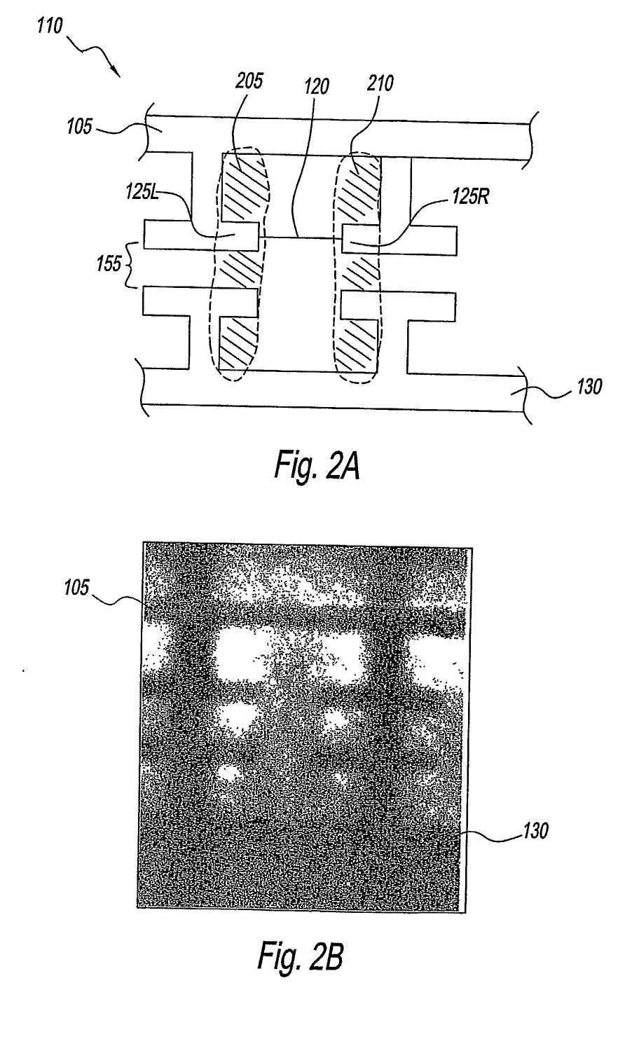

FIG. 2A is an illustration of subpixel 110, showing a formation of a discharge. Assume that for the discharge, electrode 105 has a negative charge with respect to electrode 130. The discharge is initially formed in discharge gap 155, and has a negative glow portion that spreads from discharge gap 155 to electrode 105, as ions generated in the discharge drift toward electrode 105. Conversely, and much more rapidly, a positive column, with electron flow, reaches from electrode 105 across discharge gap 155 to electrode 130. The positive column initially forms as a single positive column.

Protrusions 125L and 125R provide a low breakdown voltage path between electrodes 105 and 130 since they effectively provide a shorter discharge gap between electrodes 105 and 130. Protrusions 125L and 125R provide little charge to maintain the discharge since their area is small compared to the electrodes 105 and 130, however, electrodes 105 and 130 provide ample charge to supply the discharge. Thus, the single positive column spreads across the discharge gap 155, aided by protrusions 125L and 125R, extends between electrodes 105 and 130, and separates into two columns, namely a column 205 and a column 210. Column 205 is on the left side of gap 120, and column 210 is on the right side of gap 120.

The greater the width of gap 120, the greater is the propensity for the initial positive column to separate into separate columns, i.e., columns 205 and 210. In an exemplary implementation of subpixel 110, gap 120 has a width of about 80 microns to about 100 microns.

In subpixel 110, protrusions 125L and 125R are horizontally situated. A portion of column 205 forms above protrusion 125L, i.e., between protrusion 125L and electrode 105, and another portion of column 205 forms below protrusion 125L, i.e., between portion 125L and electrode 130. Similarly, a portion of column 210 forms above protrusion 125R, and a portion of column 210 forms below protrusion 125R.

Although not shown in FIG. 2A, column 205 also includes a portion behind protrusion 125L, and column 210 includes a portion behind protrusion 125R. If protrusions 125L and 125R are neither translucent nor transparent, then the portions of columns 205 and 210 behind protrusions 125L and 125R will not be visible. However, if protrusions 125L and 125R are configured of a translucent or transparent material, for example tin oxide or indium tin oxide, then the portions of columns 205 and 210 behind protrusions 125L and 125R will be visible.

FIG. 2B is a photograph of a discharge of subpixel 110. Columns 205 and 210 include striations, i.e., bright lines, which are characteristic of the positive column portion of a discharge. Also, the intensity of the discharge is greater in the vicinity of electrode 105 than in the vicinity of electrode 130 because the negative glow, which drifts from discharge gap 155 toward electrode 105, dissipates more power than the positive column.

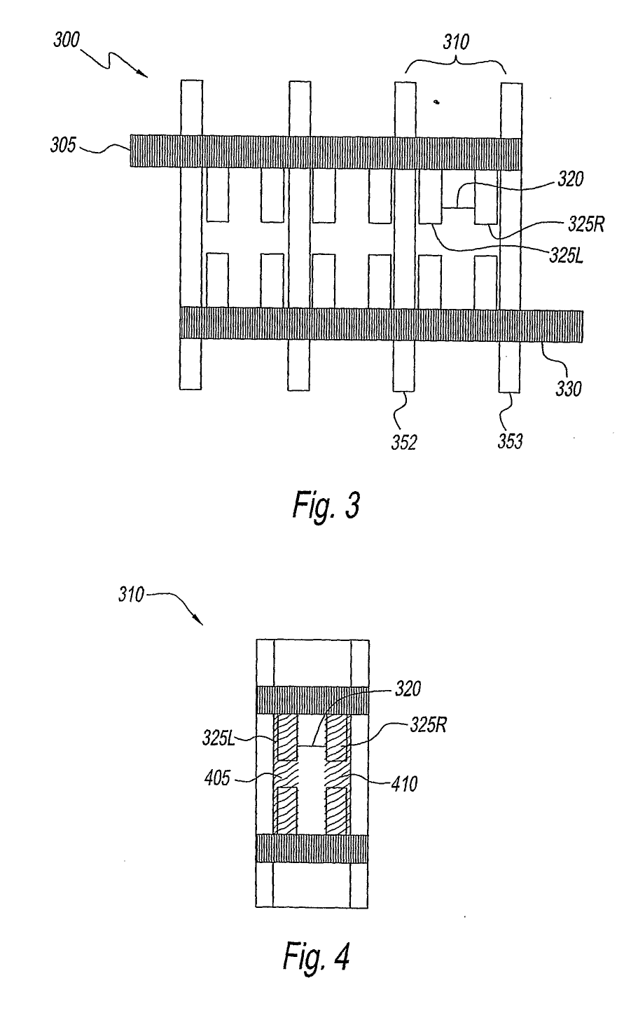

FIG. 3 is an illustration of another configuration of a pixel, i.e., a pixel 300, that produces a plurality of discharge columns. Pixel 300 includes a subpixel 310 having a region for hosting a discharge, bounded by an electrode 305, an electrode 330, and barrier ribs 352 and 353. Electrode 305 includes a protrusion 325L and a protrusion 325R, with a gap 320 therebetween.

FIG. 4 is an illustration of subpixel 310, showing a formation of a discharge. The discharge forms as a column 405 on one side of gap 320, and a column 410 on the other side of gap 320.

Protrusions 325L and 325R, unlike protrusions 125L and 125R, are not horizontally situated, and so, much of column 405 is located behind protrusion 325L, and much of column 410 is located behind protrusion 325R. To maximize the viewable areas of columns 405 and 410, protrusions 325L and 325R are configured of either a translucent or transparent material.

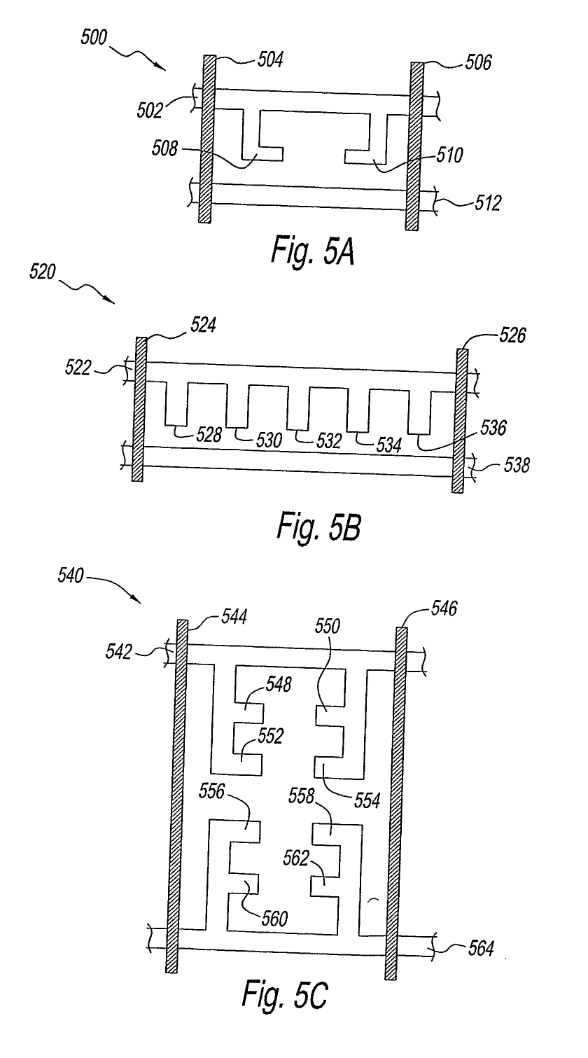

FIGS. 5A, 5B and 5C are illustrations of other configurations of subpixels that produce a plurality of discharge columns.

FIG. 5A shows a subpixel 500, configured with electrodes 502 and 512, and bounded by barrier ribs 504 and 506. Electrode 502 includes protrusions 508 and 510, but electrode 512 does not have any protrusions. Thus, opposing electrodes need not be symmetrically configured, and it is not necessary for more than one electrode to have protrusions.

FIG. 5B shows a subpixel 520, configured with electrodes 522 and 538, and bounded by barrier ribs 524 and 526. Electrode 522 includes five protrusions, namely protrusions 528, 530, 532, 534 and 536, distributed along electrode 522 in a horizontal manner. A discharge column will form adjacent to each of protrusions 528, 530, 532, 534 and 536, and so, subpixel 520 will have five discharge columns. As such, subpixel 520 can have a greater horizontal dimension than a subpixel that has no protrusions. Generally, a subpixel can include any desired number of protrusions in a horizontal arrangement to extend the horizontal dimension of the subpixel to any desired width.

FIG. 5C shows a subpixel 540, configured with electrodes 542 and 564, and bounded by barrier ribs 544 and 546. Electrode 542 includes protrusions having horizontal members 548, 550, 552 and 554. Electrode 564 includes protrusions having horizontal members 556, 558, 560 and 562. Horizontal members 548, 552, 556 and 560 are situated vertically with respect to one another, and horizontal members 550, 554, 558 and 562 are situated vertically with respect to one another. A first discharge column will form between electrodes adjacent to horizontal members 548, 552, 556 and 560, and a second discharge column will form adjacent to horizontal members 550, 554, 558 and 562. As such, subpixel 540 can have a greater vertical dimension than a subpixel that has no protrusions. Generally, a subpixel can include any desired number of vertically situated horizontal protrusions to extend the vertical dimension of the subpixel to any desired height.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

1. A plasma display, comprising a pixel that includes:
a region for hosting a discharge of a gas;
a column electrode;
a row electrode, perpendicular to said column electrode, for providing a voltage to initiate said discharge, wherein said row electrode has a first protrusion and a second protrusion; and
a gap, between said first and second protrusions, having a width that separates said first protrusion from said second protrusion, wherein said gap is situated in said region.

2. The plasma display of claim 1,
wherein said pixel has a left boundary and a right boundary, and
wherein said gap is approximately centered between said left and right boundaries.

3. The plasma display of claim 1, wherein said discharge forms as a first discharge column on a first side of said gap adjacent to said first protrusion, and a second discharge column on a second side of said gap adjacent to said second protrusion.

4. The plasma display of claim 1,
wherein said first protrusion has a horizontal member, and
wherein said discharge includes a first discharge region above said horizontal member, and a second discharge region below said horizontal member.

5. The plasma display of claim 1, wherein said width is in a range of about 80 microns to about 100 microns.

6. The plasma display of claim 1, wherein said first protrusion is configured of a translucent or transparent material.
